(19) United States
(12) Patent Application Publication
(10) Pub. No.: US 2024/0231331 A1
(43) Pub. Date: Jul. 11, 2024

(54) PRODUCTION LINE MONITORING APPARATUS, PRODUCTION LINE MONITORING SYSTEM, AND PRODUCTION LINE MONITORING METHOD

(71) Applicant: Mitsubishi Electric Corporation, Tokyo (JP)

(72) Inventors: Shaoxiang MA, Tokyo (JP); Kiyoyasu MARUYAMA, Tokyo (JP); Masahide KOIKE, Tokyo (JP)

(73) Assignee: Mitsubishi Electric Corporation, Tokyo (JP)

(21) Appl. No.: 18/289,116

(22) PCT Filed: May 11, 2021
(86) PCT No.: PCT/JP2021/017921

§ 371 Date: Nov. 1, 2023

(51) Int. Cl. G05B 19/418

(52) U.S. Cl. CPC G05B 19/4184; G05B 2219/32181

(57) ABSTRACT

A production line monitoring apparatus is an apparatus for monitoring a process in a factory production line. The production line monitoring apparatus includes an anomaly detection processing unit that detects an anomalous condition in the production line, based on videos acquired by a plurality of image-capturing units disposed in different positions outside the production line monitoring apparatus to capture images of the state of the production line, an anomaly tracking processing unit that, when an anomalous condition has been detected by the anomaly detection processing unit, creates a recorded video in which, of the videos captured by the plurality of image-capturing units, videos in which an anomalous condition identical to the detected anomalous condition is captured are connected in a time series manner, and a storage unit that stores the recorded video and accompanying information which accompanies the detected anomalous condition in association with each other.

### FIELD

The present disclosure relates to a production line monitoring apparatus, a production line monitoring system, and a production line monitoring method for monitoring a process in a factory production line.

### BACKGROUND

In recent years, automation of factories has increased by using factory automation (FA) equipment. In a factory production line, so-called “short stops”, which mean stoppages of equipment or operation due to temporary troubles or the like, cause the deterioration of the operating rate of the production line. It is thus necessary to investigate and eliminate the causes of troubles leading to the deterioration of the operating rate of the production line.

For a measure against the deterioration of the production line operating rate, a monitoring system for monitoring a process in a production line has been proposed. The monitoring system for monitoring a process in a production line captures images of the operating state of the process using a monitoring camera, and records a video of the image when an anomalous condition has been detected. This technique allows the user to check a recorded video when an anomalous condition has been detected, to identify the detected anomalous condition, and improve the deterioration of the operating rate.

Patent Literature 1 discloses a process monitoring apparatus including a camera for detecting anomalous conditions, memory for storing captured video data, and a display device for displaying an image of video data recorded in the memory. The user identifies the cause of an anomalous condition in the process by displaying a video of video data recorded in the memory.

### CITATION LIST

### Patent Literature

Patent Literature 1: Japanese Patent Application Laid-open No. 2016-122319

### SUMMARY OF INVENTION

### Problem to be Solved by the Invention

However, according to the process monitoring apparatus of Patent Literature 1, in case where a production line begins to stop at the time of detection of an anomalous condition, the position of the cause of the anomalous condition has moved until the completion of the stoppage of the production line. There is thus a problem that if the position of the cause of the anomalous condition has moved to the outside of the shooting range of the camera when the production line has stopped, the cause of the anomalous condition cannot be identified only by checking a recorded video, and it takes time to identify the cause of the anomalous condition.

The present disclosure has been made in view of the above. It is an object of the present disclosure to provide a production line monitoring apparatus that allows quick identification of the cause of an anomalous condition without being limited to the individual shooting ranges of image-capturing devices.

### Means to Solve the Problem

In order to solve the above problem and achieve the object, a production line monitoring apparatus according to the present disclosure is a production line monitoring apparatus for monitoring a process in a factory production line. The production line monitoring apparatus includes: an anomaly detection processing unit to detect an anomalous condition in the production line, based on videos acquired by a plurality of image-capturing units disposed in different positions outside the production line monitoring apparatus to capture images of a state of the production line; an anomaly tracking processing unit to, when an anomalous condition has been detected by the anomaly detection processing unit, create a recorded video in which, of the videos captured by the plurality of image-capturing units, videos in which an anomalous condition identical to the detected anomalous condition is captured are connected in a time series manner; and a storage unit to store the recorded video and accompanying information which accompanies the detected anomalous condition in association with each other.

### Effects of the Invention

The production line monitoring apparatus according to the present disclosure has the effect of allowing quick identification of the cause of an anomalous condition without being limited to the individual shooting ranges of image-capturing devices.

### BRIEF DESCRIPTION OF DRAWINGS

FIG. 1 is a diagram illustrating an FA system using a production line monitoring system according to a first embodiment.

FIG. 2 is a schematic diagram illustrating an example of a production line when an object driven by a drive unit is a belt conveyor in the first embodiment.

FIG. 3 is a schematic diagram illustrating an example of cameras disposed around the belt conveyor in the first embodiment.

FIG. 4 is a block diagram illustrating a functional configuration of each camera of the production line monitoring system according to the first embodiment.

FIG. 5 is a block diagram illustrating a functional configuration of a production line monitoring apparatus according to the first embodiment.

FIG. 6 is a flowchart illustrating an example of a processing procedure when the production line monitoring system according to the first embodiment monitors the production line.

FIG. 7 is a diagram for explaining an example of a method of calculating the travel speed of the production line from a video acquired from a camera in the first embodiment.

FIG. 8 is a diagram for explaining the movement of a mark shown in the video acquired from the camera in the first embodiment.

FIG. 9 is a diagram illustrating an example of a specific situation in the production line when an anomalous condition has been detected in the production line monitoring system according to the first embodiment.

FIG. 10 is a diagram illustrating a state in which information on a situation in which an anomalous condition has been detected by a camera and an alarm has been generated and information on a situation in which the cause of the anomalous condition is currently stopped in front of a camera are displayed on a display unit in the first embodiment.

FIG. 11 is a diagram illustrating an example of a display screen on the display unit of the production line monitoring apparatus according to the first embodiment.

FIG. 12 is a diagram illustrating an FA system using a production line monitoring system according to a second embodiment.

FIG. 13 is a block diagram illustrating a functional configuration of sensors of the production line monitoring system according to the second embodiment.

FIG. 14 is a block diagram illustrating a functional configuration of a production line monitoring apparatus according to the second embodiment.

FIG. 15 is a flowchart illustrating an example of a processing procedure when the production line monitoring system according to the second embodiment monitors a production line.

FIG. 16 is a diagram illustrating an example at the time of calculating a scanning frequency in the second embodiment.

FIG. 17 is a diagram illustrating a hardware configuration when functions of each of the production line monitoring apparatus according to the first embodiment and the production line monitoring apparatus according to the second embodiment are implemented by a computer system.

### DESCRIPTION OF EMBODIMENTS

Hereinafter, a production line monitoring apparatus, a production line monitoring system, and a production line monitoring method according to embodiments will be described in detail with reference to the drawings.

### First Embodiment

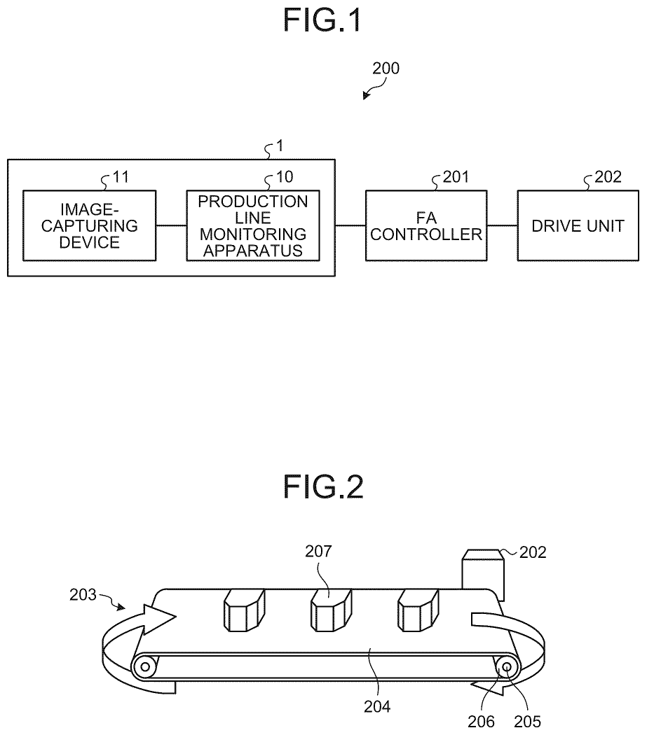

FIG. 1 is a diagram illustrating an FA system 200 using a production line monitoring system 1 according to a first embodiment. The FA system 200 according to the first embodiment is a control system including the production line monitoring system 1, a drive unit 202 that is an apparatus under control controlled to produce a product in a production line, and an FA controller 201 that is a control device controlling the drive unit 202.

The FA controller 201 controls the drive unit 202. When receiving alarm information from a production line monitoring apparatus 10 described later, the FA controller 201 performs control to stop the drive unit 202. After causing the drive unit 202 to stop, the FA controller 201 transmits stop information indicating that the drive unit 202 has stopped to the production line monitoring apparatus 10.

An alarm is a signal indicating that a specific condition that is an expected event has occurred in the production line. When an anomalous condition has occurred in the production line, the production line monitoring system 1 generates an alarm. The alarm information is information on an alarm that allows the identification of the content of the alarm generated in the production line, and is information including an alarm management number associated with the content of the alarm and the time when the alarm has been generated.

An example of the FA controller 201 is a programmable logic controller (PLC). The FA system 200 may include a motion controller that controls the drive unit 202 under the control of the FA controller 201.

The drive unit 202 is a device that supplies power to a shaft in the production line, and corresponds to a device such as a motor or an actuator. The shaft is a shaft of an apparatus in the production line. FIG. 2 is a schematic diagram illustrating an example of the production line when an object driven by the drive unit 202 is a belt conveyor in the first embodiment. In the first embodiment, a motor that is the drive unit 202 drives the belt conveyor to convey products. The products include objects conveyed in the production line, such as finished products and intermediate products.

As illustrated in FIG. 2, the drive unit 202 drives a belt conveyor 203. The belt conveyor 203 consists of an endless conveyor belt 204, a roller 206 including a roller shaft 205, and a motor that is the drive unit 202. By rotationally driving the roller shaft 205 using the motor, the conveyor belt 204 is rotated by the roller 206 to convey a product 207 on the conveyor belt 204. In the belt conveyor 203, the above-described shaft is the roller shaft 205.

The production line monitoring system 1 is a system that monitors a process in a factory production line, and includes the production line monitoring apparatus 10 and an image-capturing device 11. The production line monitoring system 1 captures images of the operating state of the production process using the image-capturing device 11, and detects an anomalous condition in the production process based on the captured operating state of the production process.

The image-capturing device 11 is an image-capturing unit that captures the state of the process in the production line. That is, the image-capturing device 11 can be said to be a state detection unit that detects the state of the process in the production line. The image-capturing device 11 includes a plurality of cameras 111 that acquire videos which are overwritable. The plurality of cameras 111 are disposed in predetermined positions different from each other where the product 207 can be captured. The shooting positions are arranged around the belt conveyor 203 driven by the motor that is the drive unit 202 in the FA system 200. The number of the cameras 111 disposed should be sufficient to monitor any process to be monitored of a plurality of processes in the production line. If it is desired to monitor all the processes in the production line, the number of the cameras 111 disposed should be sufficient to monitor all the processes.

All the cameras 111 are connected to an anomaly detection processing unit 101b to be described later so as to be able to give and receive information. That is, each camera 111 captures a video of the product 207 that has reached a predetermined shooting position on the belt conveyor 203, and transmits captured image data of the captured video to the production line monitoring apparatus 10 by wireless communication. The captured image data is sent to a scanning frequency control unit 101a to be described later and the anomaly detection processing unit 101b. The plurality of cameras 111 are independent of each other, and constantly deliver image data on captured videos to the production line monitoring apparatus 10.

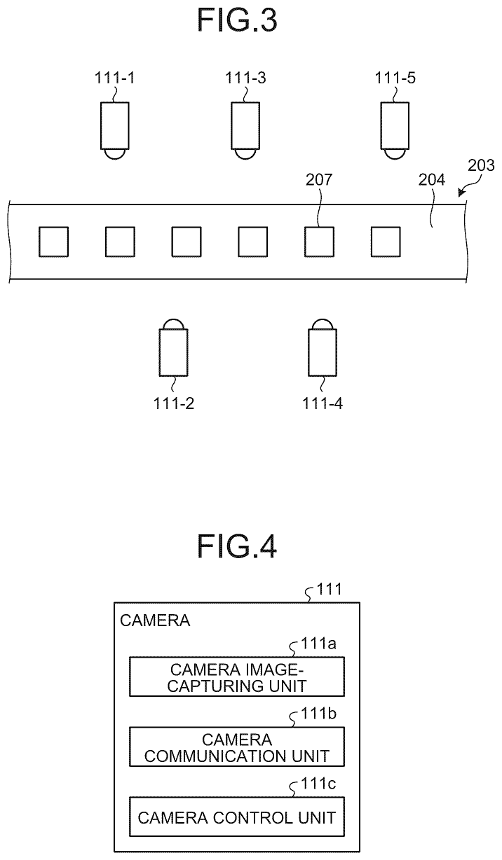

FIG. 3 is a schematic diagram illustrating an example of the cameras 111 disposed around the belt conveyor 203 in the first embodiment. In FIG. 3, the plurality of cameras 111 are disposed on the both sides which are opposite to each other with respect to the belt conveyor 203 that is the production line. A camera 111-1, a camera 111-3, and a camera 111-5 are disposed on one side of the belt conveyor 203. A camera 111-2 and a camera 111-4 are disposed on the other side of the belt conveyor 203. That is, the camera 111-2 and the camera 111-4, which are the even-numbered cameras 111, capture the product 207 from the side opposite the camera 111-1, the camera 111-3, and the camera 111-5, which are the odd-numbered cameras 111, across the production line. The cameras 111 are disposed in positions where the shooting ranges of the respective cameras 111 do not overlap with each other.

FIG. 4 is a block diagram illustrating a functional configuration of each camera 111 of the production line monitoring system 1 according to the first embodiment.

Each camera 111 includes a camera image-capturing unit 111a, a camera communication unit 111b, and a camera control unit 111c.

The camera image-capturing unit 111a is an image-capturing function unit that captures images under the control of the camera control unit 111c. The camera image-capturing unit 111a can be said to be a state information acquisition unit that acquires the state of the process in the production line.

The camera communication unit 111b performs bidirectional wireless communication with the production line monitoring apparatus 10.

The camera control unit 111c controls the entire camera 111 including the camera image-capturing unit 111a and the camera communication unit 111b. The camera control unit 111c controls the shutter speed and the shutter timing of the camera 111, based on a scanning frequency stored in advance or a scanning frequency transmitted from the scanning frequency control unit 101a.

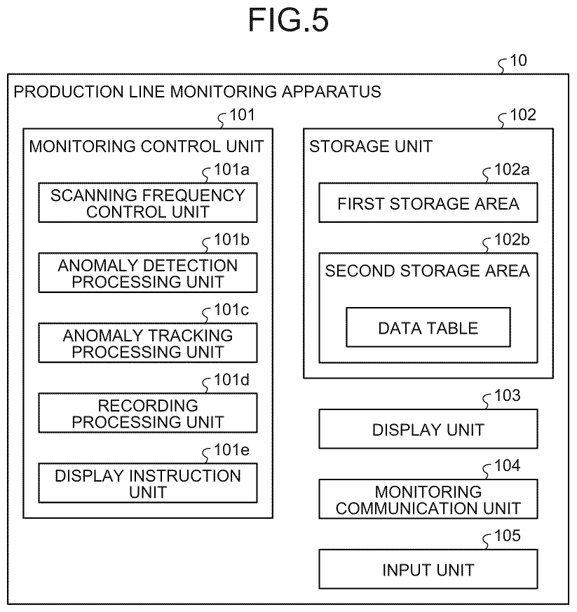

FIG. 5 is a block diagram illustrating a functional configuration of the production line monitoring apparatus 10 according to the first embodiment. The production line monitoring apparatus 10 is a monitoring apparatus for monitoring a process in a factory production line. The production line monitoring apparatus 10 detects an anomalous condition in the production process, based on the operating state of the production process captured by the image-capturing device 11. The production line monitoring apparatus 10 includes a monitoring control unit 101, a storage unit 102, a display unit 103, a monitoring communication unit 104, and an input unit 105. The components of the production line monitoring apparatus 10 can give and receive video data and information to and from each other.

The monitoring control unit 101 controls the entire production line monitoring apparatus 10. The monitoring control unit 101 includes the scanning frequency control unit 101a, the anomaly detection processing unit 101b, an anomaly tracking processing unit 101c, a recording processing unit 101d, and a display instruction unit 101e. The components of the monitoring control unit 101 can give and receive video data and information to and from each other.

The scanning frequency control unit 101a calculates an appropriate scanning frequency for collectively controlling the shutter speeds of the plurality of cameras 111, and collectively controls the shooting timings of the plurality of cameras 111. The scanning frequency control unit 101a receives video data that is video information on the process in the production line transmitted from a camera 111 via the monitoring communication unit 104. Using the video data transmitted from the camera 111, the scanning frequency control unit 101a calculates the travel speed of the production line by image processing, and calculates the scanning frequency from the calculated travel speed. The scanning frequency control unit 101a transmits the calculated scanning frequency to the plurality of cameras 111 to control the shutter speeds and the shutter timings of the plurality of cameras 111. When an object driven by the drive unit 202 is the belt conveyor 203, the travel speed of the production line can be considered as the travel speed of the conveyor belt 204 or the rotational speed of the motor that is the drive unit 202.

The scanning frequency control unit 101a stores information on a camera 111 selected in advance from the plurality of cameras 111 as one camera 111 to be subject to a calibration process. The scanning frequency control unit 101a acquires information necessary for the calculation of the scanning frequency represented by the travel speed of the production line from video data transmitted from the camera 111 subject to the calibration process, and calculates the scanning frequency. The calibration process and the calculation of the scanning frequency will be described later. The scanning frequency is control information used by the cameras 111 to control the shutter speeds and the shutter timings.

The scanning frequency control unit 101a transmits and feeds back the calculated scanning frequency to all the cameras 111 to cause the shutter speeds and the shutter timings of all the cameras 111 to be updated. This can minimize errors in time information on each other's corresponding frames between the plurality of cameras 111. That is, by updating the shutter speeds and the shutter timings using the calculated scanning frequency, all the cameras 111 can capture one frame at the same time and can capture the same number of frames in the same time period among all the cameras 111. Time information on a frame is information on the time when the frame was captured and is associated with the frame.

The anomaly detection processing unit 101b detects an anomalous condition occurring in the production line by comparing information obtained by performing image processing on images captured by the plurality of cameras 111 with information indicating the normal condition of the production line stored in advance. The information indicating the normal condition of the production line is image data on videos of the process in the production line when the production line is in a normal condition.

Anomalous conditions occurring in the production line include a condition in which a part or component in an anomalous condition whose difference from that of the normal condition is equal to or larger than a predetermined threshold has occurred on the production line, and a condition in which a foreign substance that should not be present in the production line has intruded.

The anomaly detection processing unit 101b compares images of video data acquired from the cameras 111 with the images of the video data showing the normal condition of the production line stored in advance by machine learning or the like, for all the cameras 111. That is, the anomaly detection processing unit 101b compares images captured by the cameras 111 with the images showing the normal condition of the production line. As a result of the comparison, when the product 207 or a condition in the production line whose difference is equal to or larger than the predetermined threshold is shown in the videos acquired from the cameras 111, the anomaly detection processing unit 101b determines that an anomalous condition occurring in the production line has been detected and outputs an alarm. The anomaly detection processing unit 101b transmits alarm information to the FA controller 201 via the monitoring communication unit 104.

When an anomalous condition in the production line has been detected, the anomaly detection processing unit 101b adds overwriting disabling information, that is information to prohibit overwriting on the videos, to the videos transmitted from the cameras 111 that have captured the videos in which the anomalous condition in the production line has been detected. The overwriting disabling information is information to specify the videos to be stored in the storage unit 102 as videos that cannot be overwritten in a predetermined set period and as non-overwritable videos that cannot be overwritten without receiving an instruction from the user.

The anomaly detection processing unit 101b performs image processing on the videos in which the anomalous condition in the production line has been detected. The anomaly detection processing unit 101b transmits image data on the videos that have undergone the image processing to the anomaly tracking processing unit 101c.

The image processing performed on the image data on the videos in which the anomalous condition in the production line has been detected is the addition of various types of information regarding the anomalous condition. The various types of information include a box (i.e. a frame or an unfilled box) enclosing an anomalous portion in the anomalous condition detected in the videos. The various types of information include labeling information. The labeling information is information with which each of the causes of a plurality of anomalous conditions stored in advance in the anomaly detection processing unit 101b as candidates for the cause of the anomalous condition is labeled. The various types of information include information on the position coordinates in frames in the videos of the product 207 or the condition in the production line that is the cause of the determination of the anomalous condition. The various types of information include information on the position coordinates in frames of the videos of a portion different from the normal condition.

When an anomalous condition occurring in the production line has been detected by the anomaly detection processing unit 101b, the anomaly tracking processing unit 101c performs image processing to track the anomalous condition using the information on the detected anomalous condition and the videos of the plurality of cameras 111. The videos and images captured by the cameras 111 are sometimes referred to simply as the videos and images of the cameras 111.

The anomaly tracking processing unit 101c compares videos acquired from different cameras 111 and having undergone the image processing in the anomaly detection processing unit 101b with each other. When the comparison results satisfy predetermined conditions, the anomaly tracking processing unit 101c determines that the anomalous condition even shown in the videos of the different cameras 111 is the identical anomalous condition. Then, the anomaly tracking processing unit 101c performs tracking processing on the anomalous condition occurring in the production line and stores the processing results.

The tracking processing on the anomalous condition occurring in the production line is processing to analyze, together with time information of frames of the videos, position information of the cameras 111 that have captured the videos showing the anomalous condition, to acquire in a time series manner information on a path in which the anomalous condition occurring in the production line has moved to track the path of movement of the anomalous condition occurring in the production line, and connect the videos. The position information of the cameras 111 is position information unique to each camera 111 that allows identification of the position in which each camera 111 is disposed. The tracking processing can be rephrased as processing to track a temporally continuous movement of a product or a condition on the production line that has caused the anomalous condition in the videos of the plurality of cameras 111 in which the anomalous condition has been detected.

Examples of the predetermined conditions include conditions that, of the information added to the video data by the anomaly detection processing unit 101b, the information on the position coordinates in the video frames of a product or a condition on the production line detected as the anomalous condition and the labeling information are identical, and the positions of the cameras 111 that have captured the videos in which the anomalous condition has been detected are adjacent to each other in the travel direction of the production line and the times when the anomalous condition was detected have continuity. The predetermined conditions are determined in advance and stored in the anomaly tracking processing unit 101c.

At this time, with reference to the time information on the video frames of one camera 111, the anomaly tracking processing unit 101c causes a video frame of another camera 111 closest in time and showing the identical anomalous condition to be connected. The anomaly tracking processing unit 101c likewise performs the processing to compare the videos between the plurality of cameras 111 from when the anomalous condition is detected to when the production line stops. When it is determined that the anomalous condition shown in the videos of the plurality of cameras 111 is the identical anomalous condition, the anomaly tracking processing unit 101c performs the tracking processing to track the path of movement of the anomalous condition which is shown in the videos of the plurality of cameras 111 as the identical anomalous condition, and connect the videos to create recorded video data as described above.

The recording processing unit 101d performs processing to associate accompanying information which accompanies the detected anomalous condition with the videos that have undergone the tracking processing and have been connected by the anomaly tracking processing unit 101c, and store the recorded video that has undergone the tracking processing and has been connected and the accompanying information which accompanies the anomalous condition in the storage unit 102. The video data on the recorded video that have undergone the tracking processing and have been connected are non-overwritable video data since the video data to which “the overwriting disabling information” is added are connected. The accompanying information which accompanies the anomalous condition is information regarding the anomalous condition.

The recording processing unit 101d performs recording processing to associate accompanying information which accompanies the anomalous condition that is various types of information related to the identical anomalous condition with the video data of the non-overwritable recorded video which is connected by the anomaly tracking processing unit 101c, and record them. Specifically, the recording processing unit 101d creates a data table in the storage unit 102 for the video data of the non-overwritable recorded video connected by the anomaly tracking processing unit 101c. Each data table is created for each detected anomalous condition, individually.

The recording processing unit 101d stores, in a data table corresponding to the anomalous condition, all information added, by the anomaly detection processing unit 101b, to video data on videos in which an anomalous condition in the production line has been detected. The recording processing unit 101d stores data on, of video frames, a frame having the highest accuracy in information on an anomalous condition shown therein as thumbnail image data in a data table as well. Pieces of information held and stored in one data table are pieces of information related to the identical anomalous condition. Pieces of information stored in the same data table are associated with each other.

The display instruction unit 101e is a user interface that causes the display unit 103 to display recorded information stored in the storage unit 102 in accordance with an instruction from the user. The display instruction unit 101e causes the display unit 103 to display a screen on which the user searches for or specifies information to be displayed on the display unit 103, to prompt the user to enter necessary information using the input unit 105. The user can use the input unit 105 to select and specify various types of videos or information to be displayed on the display unit 103, such as a real-time video in which no anomalous condition is detected and a video of a past anomalous condition recorded in the storage unit 102.

The display instruction unit 101e performs control to search for information specified by the user, based on information entered by the user using the input unit 105, and display the search result on the display unit 103, or display information specified by the user on the display unit 103.

The storage unit 102 holds and stores video data associated by the recording processing unit 101d and accompanying information which accompanies an anomalous condition. The storage unit 102 includes two independent different storage areas, i.e., a first storage area 102a and a second storage area 102b. The storage unit 102 stores, in the first storage area 102a, overwritable videos delivered from the cameras 111 when no anomalous condition has been detected. The storage unit 102 stores, in the second storage area 102b, video data on non-overwritable videos in which an anomalous condition has been detected and which have been processed by the anomaly detection processing unit 101b, the anomaly tracking processing unit 101c, and the recording processing unit 101d, and information related to the non-overwritable videos. The information related to the non-overwritable videos is accompanying information which accompanies the detected anomalous condition. That is, the storage unit 102 stores video data on overwritable videos, and video data on non-overwritable videos and information related to the non-overwritable videos in different storage areas. In the second storage area 102b, the above-described data tables are created by the recording processing unit 101d.

The display unit 103 displays various types of information specified by the display instruction unit 101e. The display unit 103 displays a video or information specified by the display instruction unit 101e. However, when an ongoing anomalous condition is detected, the display unit 103 preferentially displays a video and information in which the anomalous condition has been tracked and processed. The display unit 103 is exemplified by a display device such as a liquid crystal monitor.

The monitoring communication unit 104 performs wireless communication with the cameras 111 to transmit and receive video data or information. The monitoring communication unit 104 performs wireless communication with the FA controller 201 to transmit and receive information. A communication method for the monitoring communication unit 104 is not limited to wireless communication and may be wired communication.

The input unit 105 includes an input device, and receives instruction information from the user and transmits the received instruction information to the display instruction unit 101e. Examples of the input device include devices such as a keyboard and a touch panel.

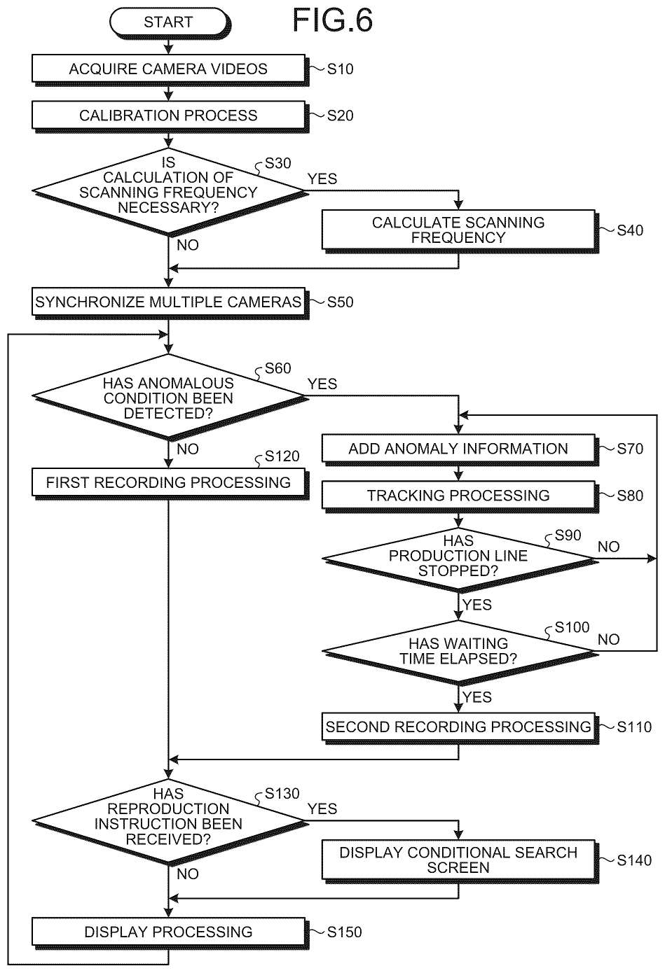

FIG. 6 is a flowchart illustrating an example of a processing procedure when the production line monitoring system 1 according to the first embodiment monitors the production line.

When the production line monitoring system 1 starts to monitor the production line, in step S10, a camera video acquisition step is performed to acquire camera videos of the production line captured by the cameras 111, which are monitoring videos of the production line to be monitored in the production line monitoring system 1. In the camera video acquisition step, the plurality of cameras 111 disposed around the production line to be monitored in the production line monitoring system 1 capture images of the production line to acquire video data on the production line. Here, the video data is overwritable video data.

The plurality of cameras 111 deliver the overwritable video data to the scanning frequency control unit 101a and the anomaly detection processing unit 101b. The scanning frequency control unit 101a and the anomaly detection processing unit 101b receive the video data from the plurality of cameras 111 to acquire the video data on the production line.

In step S20, the calibration process is performed. In the calibration process, when the travel speed of the production line is unknown, a mark that can be easily recognized is attached to the production line. Then, based on a video captured by a representative camera 111 of the plurality of cameras 111, the scanning frequency control unit 101a calculates the ratio between an actual physical length unit and a pixel length unit in the video to perform the calibration process. In addition, based on the video captured by the camera 111, the passing speed of the mark is calculated by image processing.

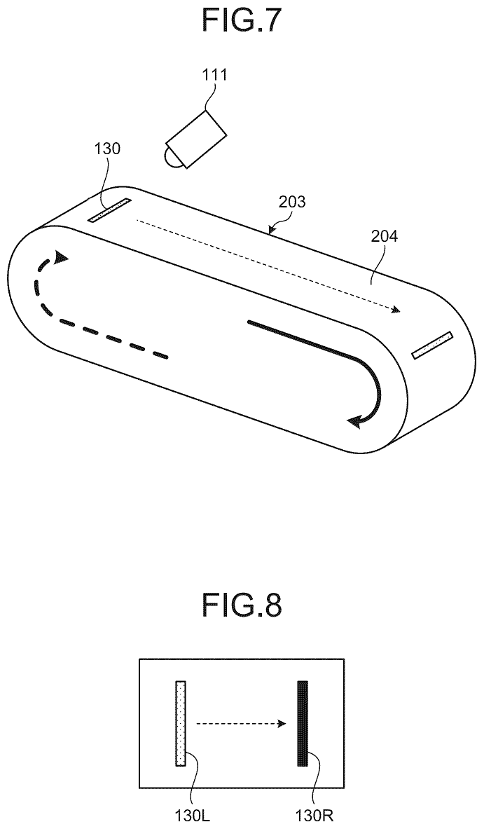

Here, a specific method of the calibration process will be described. FIG. 7 is a diagram for explaining an example of a method of calculating the travel speed of the production line from the video acquired from the camera 111 in the first embodiment. FIG. 8 is a diagram for explaining the movement of a mark 130 shown in the video acquired from the camera 111 in the first embodiment.

As illustrated in FIG. 7, the mark 130 such as a tape whose width and length are known is attached to the production line in advance. That is, the mark 130 is attached to the conveyor belt 204 in advance. Then, the mark 130 is captured by the camera 111. Next, using video data on a video captured by the camera 111, the scanning frequency control unit 101a calculates the ratio between the numerical value of the actual length of the width and length of the mark 130 and the numerical value of the pixel length of the mark 130 shown in the video by image processing, with the numerical value of the known actual length of the width and length of the mark 130 as an input value.

At this time, due to the distortion of a lens of the camera 111, the ratio changes toward the image edges in the video. Therefore, the scanning frequency control unit 101a performs lens distortion correction for correcting the influence of the lens distortion to calculate a constant ratio according to images shown in the video. In the first embodiment, this process is defined as the calibration process.

In FIG. 8, a mark 130L on the left side indicates the mark 130 in one frame in the captured video. In FIG. 8, a mark 130R on the right side indicates the mark 130 in the next frame in the captured video. That is, the mark 130 has traveled from the position of the mark 130L on the left side to the position of the mark 130R on the right side between the two consecutive frames of the captured video. The distance traveled by the mark 130 in the video from the position of the mark 130L on the left side to the position of the mark 130R on the right side is the travel distance in pixel length of the mark 130 shown in the video.

The scanning frequency control unit 101a calculates the actual travel distance of the mark 130 in a one-frame time period based on the travel distance of the mark 130 in pixel length between the frames of the captured video, using the calculated ratio. The scanning frequency control unit 101a calculates the travel speed of the production line based on the calculated actual travel distance of the mark 130 and the one-frame time period. The scanning frequency control unit 101a performs the above calculation a plurality of times to calculate the mean value of the travel speed of the production line.

In step S30, it is determined whether or not it is necessary to calculate the scanning frequency for collectively controlling the shutter speeds of the plurality of cameras 111. That is, the presence or absence of the need to acquire the scanning frequency is determined. Specifically, the scanning frequency control unit 101a performs processing to determine whether it is necessary to acquire the scanning frequency for controlling the shutter speeds of the cameras 111.

When the scanning frequency control unit 101a does not hold the value of the scanning frequency at the startup of the production line monitoring system 1, such as when the production line monitoring system 1 is installed in a new environment, the scanning frequency control unit 101a determines that acquisition of the scanning frequency is necessary. When the scanning frequency control unit 101a holds the value of the scanning frequency at the startup of the production line monitoring system 1, such as when the production line monitoring system 1 is started in an existing environment, the scanning frequency control unit 101a determines that acquisition of the scanning frequency is unnecessary.

When it is determined that the scanning frequency needs to be acquired, Yes is selected in step S30, and the process proceeds to step S40. When it is determined that the scanning frequency does not need to be acquired, No is selected in step S30, and the process proceeds to step S50.

In step S40, the scanning frequency is calculated. Specifically, the scanning frequency control unit 101a performs processing to calculate a scanning frequency appropriate for all the cameras 111, using the mean value of the travel speed of the production line acquired by the calibration process from one representative camera 111 of the plurality of cameras 111. The calculated scanning frequency is stored and held in the scanning frequency control unit 101a.

Here, a specific method of calculating the scanning frequency from the calibration process will be described. The appropriate scanning frequency is the reciprocal of the number of seconds required for all pixels of an image sensor included in each camera 111 to receive light at one exposure to excite electric charges in the camera 111. This appropriate scanning frequency has the same value as the reciprocal of the minimum shutter speed at which, when capturing a moving object, the cameras 111 can show the captured object without blurring in all captured frames.

In order for the object to be captured to be imaged without blurring in a frame, the distance traveled by the object to be captured in the time period of the minimum shutter speed needs to be within an allowable blurring range that is a blurring range allowed to capture the object to be captured without blurring in a frame. The object to be captured travels at a travel speed of R [m/sec] of the production line obtained from the calibration result. The scanning frequency control unit 101a converts the travel speed in the video into R′ [px/sec], using the ratio between the actual length obtained by the calibration process and the pixel length in the images. An appropriate minimum shutter speed ω [sec] is calculated by formula (1) below, where x [pixel (px)] is the allowable blurring range in one video frame.

$$ω = x / {R}^{′} \qquad ( 1 )$$

The appropriate scanning frequency can be expressed as 1/ω [Hz], which is the reciprocal of the minimum shutter speed ω [sec] calculated by formula (1).

Next, in step S50, synchronization processing of the plurality of cameras 111 is performed. In the synchronization processing of the plurality of cameras 111, specifically, the scanning frequency control unit 101a transmits and feeds back the calculated scanning frequency to all the cameras 111. All the cameras 111 receive the scanning frequency transmitted from the scanning frequency control unit 101a. The shutter speeds of the cameras 111 are determined based on the value of the scanning frequency transmitted from the scanning frequency control unit 101a and become all the same value.

The scanning frequency control unit 101a transmits, together with the scanning frequency, information on a time just coming to all the cameras 111 as information specifying the time to change the shutter speeds of the cameras 111 and start delivery of videos from the cameras 111. Thus, the scanning frequency control unit 101a performs processing to synchronize the shooting timings of the cameras 111, that is, the shutter timings of the cameras 111.

According to the information on the just-coming time received from the scanning frequency control unit 101a, each camera 111 changes the shutter speed based on the received scanning frequency and starts to deliver a video to the scanning frequency control unit 101a and the anomaly detection processing unit 101b. By all the cameras 111 performing the above processing for synchronization, errors in time information on frames of videos captured by the cameras 111 can be minimized as much as possible. By minimizing errors in frame time information between frames in videos captured by the cameras 111 between the cameras 111, temporally cross-references become possible between video frames captured by different cameras 111.

In step S60, an anomaly detection step of detecting an anomalous condition is performed to determine whether or not an anomalous condition has been detected in the production line. Specifically, the anomaly detection processing unit 101b compares the video data acquired from the plurality of cameras 111 with the video data indicating the normal condition of the production line stored in advance, to detect an anomalous condition occurring in the production line. That is, the anomaly detection processing unit 101b compares current videos of the production line acquired from the plurality of cameras 111 with the videos showing the production line in the normal condition stored in advance, to detect an anomalous condition occurring in the production line.

When it is determined that an anomalous condition has been detected in the production line, Yes is selected in step S60, and the process proceeds to step S70. When it is determined that no anomalous condition has been detected in the production line, No is selected in step S60, and the process proceeds to step S120.

In step S70, an anomaly information addition step of adding anomaly information that is information regarding the anomalous condition is performed. The information regarding the anomalous condition is accompanying information which accompanies the anomalous condition. Specifically, the anomaly detection processing unit 101b adds a box enclosing an anomalous portion of the anomalous condition detected in the videos to the respective frames of the videos. The anomaly detection processing unit 101b adds header information that is overwriting disabling information to prohibit overwriting on the videos to the video data delivered from the cameras 111. The anomaly detection processing unit 101b performs processing to add information such as labeling information, information on the position coordinates in the video frames of an object detected as the anomalous condition detected in the video frames, and information on the position coordinates in the video frames of a portion different from the normal condition, as information regarding the anomalous condition added to the video data of the cameras 111.

Next, in step S80, a tracking processing step of performing anomalous condition tracking processing is performed. Specifically, the anomaly tracking processing unit 101c compares the information regarding the anomalous condition added to the videos acquired from the plurality of cameras 111 in step S70, to determine whether or not the detected anomalous condition is identical between the plurality of cameras 111. When it is determined that the anomalous condition detected in the videos of the plurality of cameras 111 is the identical anomalous condition, the anomaly tracking processing unit 101c performs processing to track the temporally continuous movement of the product 207 or a condition in the production line that has caused the anomalous condition in the videos of the plurality of cameras 111 in which the anomalous condition has been detected.

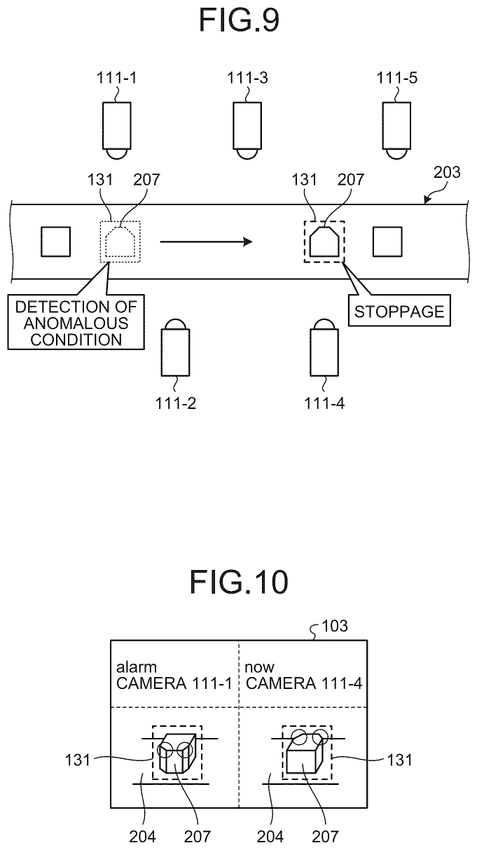

Here, a flow of image processing in the tracking processing will be described using a specific example. FIG. 9 is a diagram illustrating an example of a specific situation in the production line when an anomalous condition has been detected in the production line monitoring system 1 according to the first embodiment. The situation illustrated in FIG. 9 is a situation in which an anomalous condition has been detected in a video captured by the camera 111-1, the FA controller 201 has been notified of an alarm and the production line has stopped, and an object causing the anomalous condition has moved before the stoppage of the production line and stopped in front of the camera 111-4. A state in which the production line has stopped is a state in which the drive unit 202 has stopped and the conveyance of the product by the belt conveyor 203 has stopped.

The following describes details of the processing until it is determined that the anomalous condition detected in the video captured by the camera 111-1 is the anomalous condition identical to the anomalous condition that has stopped in front of the camera 111-4. First, when detecting an anomalous condition from video data transmitted from the camera 111-1, the anomaly detection processing unit 101b performs image processing to add a box enclosing the product 207 or a condition in the production line found to be the anomalous condition in the video. The box is added to all frames of the video data transmitted from the camera 111-1.

Then, the anomaly detection processing unit 101b adds, to the video data frames, labeling information on the cause of an anomaly estimated to correspond to the detected anomalous condition, of labeling information on the causes of a plurality of anomalies stored in advance in the anomaly detection processing unit 101b as candidates for the cause of the anomalous condition, and information on the position coordinates in the frames of the anomalous condition in the box. The anomaly detection processing unit 101b stores and holds the labeling information and the position coordinate information as information on the camera 111-1. The information on the camera 111-1 is information on the cameras 111.

When the product 207 or the condition in the production line that has caused the anomalous condition goes out of the shooting range of the camera 111-1 and enters the shooting range of another camera 111, and the anomalous condition is detected in a video captured by that camera 111, the anomaly detection processing unit 101b also adds a box, labeling information, and information on the position coordinates in frames of the anomalous condition in the box to the video captured by that camera 111, and stores and holds the box, the labeling information, and the position coordinate information as information on that camera 111 as described above, as is the case with the camera 111-1 described above. For the plurality of cameras 111, the anomaly detection processing unit 101b transmits video data on videos captured by the cameras 111 and information on the cameras 111 to the anomaly tracking processing unit 101c.

The anomaly tracking processing unit 101c receives the video data on the video captured by each camera 111 and the information on each camera 111 from the anomaly detection processing unit 101b for the plurality of cameras 111. The anomaly tracking processing unit 101c compares the information on the cameras 111 from when the anomalous condition is first detected to when the anomalous condition is eliminated and the operation of the production line is resumed. The anomaly tracking processing unit 101c has set in advance conditions such as whether the pieces of labeling information in the information on the cameras 111 about the plurality of cameras 111 match, whether the pieces of information on the position coordinates in the frames of the anomalous condition in the box in the information on the cameras 111 about the plurality of cameras 111 are close in value, and whether pieces of shooting time information added to the imaged frames are close in time. The shooting time information added to the imaged frames is information on the times when the imaged frames were captured.

If the information on the cameras 111 about different cameras 111 satisfies these conditions, the anomaly tracking processing unit 101c determines that the anomalous condition shown in the videos of the different cameras 111 is the identical anomalous condition. Then, the anomaly tracking processing unit 101c tracks a path in which the anomalous condition detected by the plurality of cameras 111 has moved.

In the situation illustrated in FIG. 9, the anomaly detection processing unit 101b has determined that the product 207 is an anomalous condition different from the normal condition in the video captured by the camera 111-1. In addition, the anomaly detection processing unit 101b has determined that the product 207 is an anomalous condition different from the normal condition in a video captured by each of the camera 111-2, the camera 111-3, and the camera 111-4. At this time, for the anomalous condition detected in the video captured by each camera 111, the anomaly detection processing unit 101b adds a box, labeling information, and information on the position coordinates in frames of the anomalous condition in the box to the captured video as described above, and stores and holds the box, the labeling information, and the position coordinate information as information on the camera 111.

Here, the even-numbered cameras 111 are disposed opposite the odd-numbered cameras 111 across the belt conveyor 203 that is the production line. That is, the even-numbered cameras 111 capture images of the production line from the side opposite the odd-numbered cameras 111 across the belt conveyor 203 as the production line. Therefore, the anomaly tracking processing unit 101c unifies the position coordinates in the videos captured by the even-numbered cameras 111 and the videos captured by the odd-numbered cameras 111, to compare the coordinate position information. That is, the anomaly tracking processing unit 101c vertically inverts the position coordinates in the frames to which the box is added upon the detection, to compare the coordinate position information.

These pieces of information on the cameras 111, position information of the adjacent cameras 111, shooting time information on the last frame of a video showing the anomalous condition detected in the video of a certain camera 111, and shooting time information on the first frame of a video showing the anomalous condition detected in the video of a camera 111 in the position next to the certain camera 111 in the travel direction of the production line are transmitted from the anomaly detection processing unit 101b to the anomaly tracking processing unit 101c. The anomaly tracking processing unit 101c compares these pieces of information on the plurality of cameras 111. From the results of the comparison, the anomaly tracking processing unit 101c determines whether the anomalous condition captured by the plurality of cameras 111 is the identical anomalous condition. When it is determined that the anomalous condition shown in the videos of the plurality of cameras 111 is the identical anomalous condition, the anomaly tracking processing unit 101c connects the last frame of the video of each camera 111 showing the anomalous condition to the first frame of the video of the next adjacent camera showing the anomalous condition.

The anomalous condition similarly detected in the video captured by each camera 111 other than the camera 111-1 is compared, by the anomaly tracking processing unit 101c, with the anomalous condition detected in the video of the camera 111-1 that is the cause of the alarm when the production line has stopped to determine the identity as described above. This shows that the generated anomalous condition has been first detected in the video captured by the camera 111-1 and passed in front of the camera 111-2 and the camera 111-3, and is currently located in front of the camera 111-4 and continues to be shown in the video of the camera 111-4.

In a video of the camera 111-5, the same anomalous condition is not shown and detected. From this, the anomaly tracking processing unit 101c determines that the anomalous condition first detected in the video of the camera 111-1 is currently in a state of being stopped in front of the camera 111-4.

Based on the results of the determination of the anomaly tracking processing unit 101c, the display instruction unit 101e causes the display unit 103 to display information on the situation in which the anomalous condition has been detected by the camera 111-1 and the alarm has been generated and information on the situation in which the cause due to which the anomalous condition occurs is currently stopped in front of the camera 111-4 so as to notify the user of the information. That is, the anomaly tracking processing unit 101c transmits, to the display instruction unit 101e, the video when the anomalous condition has been first detected in the video of the camera 111-1 and the real-time video of the camera 111-4. The display instruction unit 101e causes the display unit 103 to display the videos. This can prompt the user to quickly eliminate the anomalous condition.

FIG. 10 is a diagram illustrating a state in which the information on the situation in which the anomalous condition has been detected by the camera 111-1 and the alarm has been generated and information on the situation in which the cause of the anomalous condition is currently stopped in front of the camera 111-4 are displayed on the display unit 103 in the first embodiment. As illustrated in FIG. 10, on the display unit 103, the video of the camera 111-1 of the situation in which the anomalous condition has been first detected by the camera 111-1 and the alarm has been generated is displayed in a left area, and the video of the camera 111-4 of the situation in which the object causing the anomalous condition is stopped in front of the camera 111-4 is displayed in a right area.

Next, in step S90, the anomaly tracking processing unit 101c determines whether or not the production line has stopped. After causing the drive unit 202 to stop, the FA controller 201 transmits stop information indicating that the drive unit 202 has stopped to the production line monitoring apparatus 10. When the anomaly tracking processing unit 101c has received the stop information via the monitoring communication unit 104, the anomaly tracking processing unit 101c determines that the production line has stopped. When the anomaly tracking processing unit 101c has not received the stop information, the anomaly tracking processing unit 101c determines that the production line has not stopped.

When it is determined that the production line has not stopped, No is selected in step S90, and the process returns to step S70. When it is determined that the production line has stopped, Yes is selected in step S90, and the process proceeds to step S100.

In step S100, the anomaly tracking processing unit 101c determines whether or not a predetermined waiting time has elapsed since an anomalous condition which was determined to be the identical anomalous condition has no longer been detected in the videos of the plurality of cameras 111.

When it is determined that the predetermined waiting time has not elapsed, No is selected in step S100, and the process returns to step S70. When it is determined that the predetermined waiting time has elapsed, Yes is selected in step S100, and the process proceeds to step S110.

Here, when Yes is selected in step S90 and further Yes is selected in step S100, the process proceeds to step S110 in the flow. However, the flow may be changed so that when one of the conditions in step S90 and step S100 is satisfied, the process proceeds to step S110. That is, steps S70 and S80 may be performed in a loop until the production line is stopped based on the detection of the anomalous condition or the predetermined waiting time has elapsed since an anomalous condition determined to be the identical anomalous condition has no longer been detected in the videos of the plurality of cameras 111.

In step S110, second recording processing is performed by the recording processing unit 101d. Processing performed in the second recording processing includes two processes.

A first process is to connect, into one recorded video, frames that can be estimated to be temporally continuous for the videos of the plurality of cameras 111 showing the anomalous condition determined to be the identical anomalous condition by the anomaly tracking processing unit 101c.

A second process is a process in which the recording processing unit 101d creates a data table in the storage unit 102, and additionally stores, to the data table, the position information of the camera 111 that has first detected the anomalous condition, the pieces of information added in step S70, the current position information on the anomalous condition when the production line has stopped, and thumbnail image data, so that the pieces of these information can be recorded in association with the data on the recorded video in which the videos showing the anomalous condition are connected. That is, the storage unit 102 includes the position information of the plurality of cameras 111, and when an anomalous condition has been detected by the anomaly detection processing unit 101b, information on the cameras 111 that have captured videos in which the anomalous condition has been detected, position information of the cameras 111 that have captured videos in which the anomalous condition has been detected, and a thumbnail image that is a captured image of the detected anomalous condition are recorded in association with the videos showing the anomalous condition.

If the anomalous condition is currently being captured by a camera 111, the current position information on the anomalous condition when the production line has stopped is the position information of the camera 111 that is currently capturing the anomalous condition. If the anomalous condition is not currently being captured by any camera 111, the current position information on the anomalous condition when the production line has stopped is position information on the anomalous condition estimated from a camera 111 that has captured the anomalous condition last. For the thumbnail image data, whether the accuracy of the information on the anomalous condition shown in the videos in which the anomalous condition is being detected is high and the entire anomalous condition is shown is quantified as reliability. The thumbnail image data is data on a thumbnail image that has a frame having the highest numerical value of the reliability and is a static image. In other words, the thumbnail image data is data on a thumbnail image obtained by selecting a recorded image having the best image quality from among recorded images showing the object that is the cause of the anomalous condition when the alarm is generated due to detection of the anomalous condition, and converting the recorded image into a thumbnail.

The processing results of performing the second recording processing and the video data that has undergone the second recording processing are stored and saved in the data table. Thereafter, the process proceeds to step S130.

In addition to the above information, information to be associated with the recorded video may be added to the information to be stored in the data table by the recording processing unit 101d. For example, information on the number of detections of the same anomalous condition on the same day, information on equipment disposed near a camera 111 whose number of first detections of the same anomalous condition is large, or information on a predictive risk advice to people etc. may be additionally stored in the data table.

On the other hand, in step S120, first recording processing is performed. In the first recording processing, the recording processing unit 101d acquires, from the anomaly detection processing unit 101b, overwritable videos delivered from the cameras 111 when no anomalous condition has been detected, and stores and saves the acquired videos in the first storage area 102a of the storage unit 102. That is, when no anomalous condition has been detected by the anomaly detection processing unit 101b, the videos of the cameras 111 are stored in the storage unit 102 as overwritable videos. When the detected anomalous condition is eliminated from the production line and the operation of the stopped production line is resumed, the state of detection of the anomalous condition in the anomaly detection processing unit 101b in step S60 is reset, and the process returns to step S10.

In and after step S130, processing related to display of videos or information stored in the storage unit 102 is performed.

In step S130, it is determined whether or not a reproduction instruction has been received. Specifically, the display instruction unit 101e determines whether or not an instruction to reproduce a video or information stored in the storage unit 102 has been received from the input unit 105.

When it is determined that a reproduction instruction has been received, Yes is selected in step S130, and the process proceeds to step S140. When it is determined that no reproduction instruction has been received, No is selected in step S130, and the process proceeds to step S150.

In step S140, the display instruction unit 101e causes the display unit 103 to display a conditional search screen for the user to search for or specify information to be displayed on the display unit 103, to prompt the user to enter necessary information using the input unit 105. The display instruction unit 101e accesses the storage unit 102 and performs processing to display, on the display unit 103, thumbnail images of some non-overwritable recorded videos stored at times close to the time of the access, and the conditional search screen.

From the displayed conditional search screen, the user can search for a desired recorded video based on a condition such as the time when an anomalous condition occurred or the position information of a camera 111, and the thumbnail images, and instruct the display unit 103 to display the recorded video. When an instruction to reproduce a video or information stored in the storage unit 102 is entered from the input unit 105 by the user, the input unit 105 transmits the reproduction instruction to the display instruction unit 101e. Thereafter, the process proceeds to step S150.

In step S150, when it is determined in step S130 that a reproduction instruction has not been received, and the process proceeds from step S130 to step S150, the display instruction unit 101e causes the display unit 103 to display overwritable videos constantly delivered from the cameras 111 in real time. The display instruction unit 101e may acquire overwritable videos constantly delivered from the cameras 111 from the monitoring communication unit 104 or from the storage unit 102.

In step S150, when it is determined in step S130 that a reproduction instruction has been received and the process proceeds from step S140 to step S150, the recorded video to which the anomaly information that is information regarding the anomalous condition has been added in step S70 and which is the result of the anomalous condition tracking processing performed in step S80 is displayed together with the video when the anomalous condition has been detected and the result of the determination of the current position information on the anomalous condition when the production line has stopped on which the second recording processing has been performed in step S110. In the video on which the second recording processing has been performed in step S110, the current position information on the anomalous condition when the production line has stopped included in the result of the determination of the current position information on the anomalous condition when the production line has stopped on which the second recording processing has been performed in step S110 is the position information of the camera 111 that is currently capturing the anomalous condition if the anomalous condition is currently being captured by the camera 111. If the anomalous condition is not currently being captured by any camera 111, the current position information on the anomalous condition when the production line has stopped is position information on the anomalous condition estimated from a camera 111 that has captured the anomalous condition last.

When a selection is made from candidate results retrieved using a condition such as date and time information or labeling information on the conditional search screen displayed in step S140, or when a thumbnail image is selected, the display instruction unit 101e causes the display unit 103 to display a recorded video and accompanying information showing a recorded video stored in the storage unit 102 and accompanying information which accompanies an anomalous condition related to the recorded video.

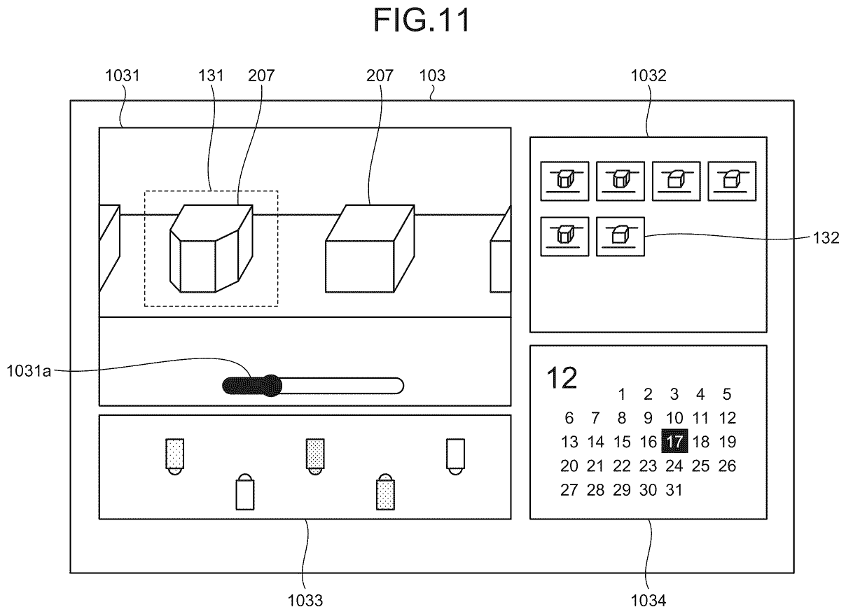

FIG. 11 is a diagram illustrating an example of a display screen on the display unit 103 of the production line monitoring apparatus 10 according to the first embodiment. On the display screen displayed on the display unit 103 illustrated in FIG. 11, when the user specifies a video to be reproduced, the user can perform a search using, as a keyword, labeling information regarding an anomalous condition or information on the date and time when a video in which an anomalous condition was detected was captured, and can display the search result.

On the display screen displayed on the display unit 103 illustrated in FIG. 11, a video display area 1031, a thumbnail display area 1032, an accompanying information display area 1033, and a date and time information display area 1034 are displayed.

In the thumbnail display area 1032, thumbnail images 132 that fit the results of a search with a keyword input from the user and are displayed using data on the thumbnail images 132 stored in a data table of the storage unit 102 are displayed side by side as candidates for the user's search target. By the thumbnail images 132 that are candidates for the user's search target being displayed in the thumbnail display area 1032, the user who gives a reproduction instruction can view the thumbnail images 132 that are candidates for the user's search target by entering a small number of search conditions.

By selecting a desired thumbnail image 132 from the thumbnail images 132 displayed in the thumbnail display area 1032, the user can display a recorded video corresponding to the selected thumbnail image 132 stored in the storage unit 102 in the video display area 1031. This can reduce a burden on the user when searching for a desired recorded video and displaying the desired recorded video in the video display area 1031, and improve recorded video searchability.

In the video display area 1031, a recorded video recorded in the storage unit 102 that has undergone the tracking processing and shows an anomalous condition is displayed. When the user selects a thumbnail image 132 displayed in thumbnail display area 1032, a recorded video is displayed in the video display area 1031 with a small number of operations. In the video displayed in the video display area 1031, the detected anomalous condition is enclosed by a box 131. By using a slide bar 1031a displayed in the video display area 1031, the recorded video at a desired timing can be viewed.

In the accompanying information display area 1033, for example, the position information of the plurality of cameras 111 is displayed. In addition, in the accompanying information display area 1033, position information of the cameras 111 under various conditions, such as the position of a camera 111 when a video is being displayed and when an anomalous condition has first been detected, the position of a camera 111 that has captured a video being currently displayed in the video display area 1031, and the position of a camera 111 when the production line has stopped, is displayed. By entering information to select a camera 111 using the input unit 105, a recorded video corresponding to a video captured by the selected camera 111 can be displayed in the video display area 1031.

The date and time information display area 1034 displays information on the date and time that fit the results of searching for information that the user wants to display on the display unit 103 on the conditional search screen. By additionally specifying a date and time, a list of candidate thumbnail images can be displayed in the thumbnail display area 1032.

As described above, in the production line monitoring system 1 according to the first embodiment, even when the travel speed of the production line is unknown, the production line monitoring apparatus 10 can calculate the scanning frequency to optimize the shutter timings of the plurality of cameras 111 by performing the calibration process. Since the scanning frequency shared by all the cameras 111 in the production line monitoring system 1 can be calculated by the scanning frequency control unit 101a, the introduction and the synchronization control of the plurality of cameras 111 are easier than in a monitoring system in which a plurality of single cameras are introduced.

In the production line monitoring system 1, the shutter timings of the cameras 111 are optimized by the scanning frequency control unit 101a, so that a monitored object and the production line can be captured properly frame by frame without blurring of the monitored object in the production line, to monitor the monitored object and the production line. Consequently, the production line monitoring system 1 can increase the rate of detection of anomalous conditions by image processing.

In the production line monitoring system 1, the anomaly detection processing unit 101b detects an anomalous condition in real time by image processing, and adds various types of information regarding the anomalous condition such as the box 131 to a video in which the anomalous condition has been detected. Thus, the production line monitoring system 1 allows more quick and more specific identification of a generated anomalous condition when checking a video.

In the production line monitoring system 1, the anomaly tracking processing unit 101c determines whether an anomalous condition detected in videos of the plurality of cameras 111 is the identical anomalous condition by comparing information regarding the anomalous condition detected in the videos of the plurality of cameras 111 with the continuity of time information on frames of the videos of the plurality of cameras 111. When it is determined that the anomalous condition detected in the videos of the plurality of cameras 111 is the identical anomalous condition, the anomaly tracking processing unit 101c performs the tracking processing to track the path of movement of the detected anomalous condition and connect the videos showing the anomalous condition. Then, the anomaly tracking processing unit 101c connects the videos of the plurality of cameras 111 whose shooting ranges do not overlap, to create a recorded video that allows the identification of the path of movement of the anomalous condition. This allows the user to check the recorded video to quickly identify the cause of the anomalous condition without being limited to the individual shooting ranges of the cameras 111. Then, the line of flow that is the path of movement of the anomalous condition is derived, and a position where the anomalous condition is likely to occur in the production line can be grasped, which contributes to the preventive maintenance of equipment in the production line.

In the production line monitoring system 1, when an anomalous condition has been detected by the anomaly detection processing unit 101b and the production line has stopped, the identical anomalous condition which has been detected until the production line has stopped is tracked by the anomaly tracking processing unit 101c. Consequently, if the anomalous condition is shown in any of the videos of the plurality of cameras 111, the position of the camera 111 capturing the anomalous condition can be presented to the user as the current position of the anomalous condition that has stopped in the production line. If the anomalous condition is not shown in any of the videos of the plurality of cameras 111, the estimated current position of the anomalous condition which is estimated from the position of the camera 111 that has captured the anomalous condition last can be presented to the user as the current position of the anomalous condition. This allows the user to quickly grasp the current position of the cause of the anomalous condition to quickly eliminate the cause of the anomalous condition from the production line, and quickly resume the operation of the production line.

In the production line monitoring system 1, when no anomalous condition is detected, the recording processing unit 101d causes the storage unit 102 to store videos of the cameras 111 as overwritable recorded videos. When an anomalous condition has been detected, the recording processing unit 101d adds overwriting disabling information to video data showing the anomalous condition so that the video data cannot be overwritten and deleted for a certain period of time and without the user's instruction. Consequently, the production line monitoring system 1 can efficiently use the capacity of the storage unit 102.

In the production line monitoring system 1, when an anomalous condition has been detected, various types of information accompanying the anomalous condition are stored in a data table of videos processed to be non-overwritable and recorded in the storage unit 102. The various types of information accompanying the anomalous condition include the position information of the cameras 111 that have detected the anomalous condition, the information on the anomaly detection times of the cameras 111, the information on the position coordinates in frames for determining whether the anomalous condition detected in images of the videos of the cameras 111 is identical, the current position information on the detected anomalous condition or the estimated current position information on the anomalous condition at present, and the information on the thumbnail images 132 that are one-frame image information in which the detected anomalous condition is clearly shown, and these information included in the various types of information are sent from the anomaly detection processing unit 101b. This can increase the number of candidates for information required when the user searches for a past anomalous condition, and can improve the searchability of a recorded video that is the result of tracking of the anomalous condition.

In the production line monitoring system 1, various types of information that are associated with a recorded video by the recording processing unit 101d can be displayed on the display unit 103 in an easy-to-understand manner. Further, the thumbnail image 132 obtained by selecting a recorded image having the best image quality from among recorded images showing an object that is the cause of an anomalous condition when an alarm is generated due to detection of the anomalous condition, and converting the recorded image into a thumbnail can be displayed on the display unit 103. Consequently, the production line monitoring system 1 can improve the visibility of a generated anomalous condition on an instruction screen at the time of instructing the reproduction of a video showing the anomalous condition.

Namely, the production line monitoring system 1 records a recorded video created by the tracking processing and accompanying information which accompanies an anomalous condition such as the position information of the camera 111 that has first detected an anomalous condition in association with the recorded video. As a result, the production line monitoring system 1 can improve visibility and searchability when the user gives an instruction to reproduce a recorded video.

As described above, in the production line monitoring system 1 according to the first embodiment, when it is determined that an anomalous condition detected in videos of the plurality of cameras 111 is the identical anomalous condition, the anomaly tracking processing unit 101c performs the tracking processing to track the path of movement of the detected anomalous condition and connect the videos showing the anomalous condition. Then, the anomaly tracking processing unit 101c connects the videos of the plurality of cameras 111 whose shooting ranges do not overlap, to create a recorded video that allows the identification of the path of movement of the anomalous condition. This allows the user to check the recorded video to quickly identify the cause of the anomalous condition without being limited to the individual shooting ranges of the cameras 111.

The production line monitoring system 1 causes all the cameras 111 to capture images based on the same scanning frequency and controls the shooting timings of the plurality of cameras 111. As a result, the production line monitoring system 1 allows tracking of the cause of an anomalous condition detected in captured videos, quick identification of the position of the anomalous condition when the production line has stopped at the time of detection of the anomalous condition, and easy elimination of the cause of the anomalous condition.

The production line monitoring system 1, in which when an anomalous condition is detected, information on the cause of the anomalous condition such as a captured image of the cause of the anomalous condition and position information of a camera 111 that has first detected the anomalous condition is stored in the storage unit 102 in association with videos of the cameras 111, and the information is converted into thumbnails when displayed to improve visibility and searchability, has the effect of being able to contribute to quick discovery of the cause of the anomalous condition.

Thus, the production line monitoring system 1 according to the first embodiment has the effect of allowing quick identification of the cause of an anomalous condition without being limited to the individual shooting ranges of the image-capturing device 11.

### Second Embodiment

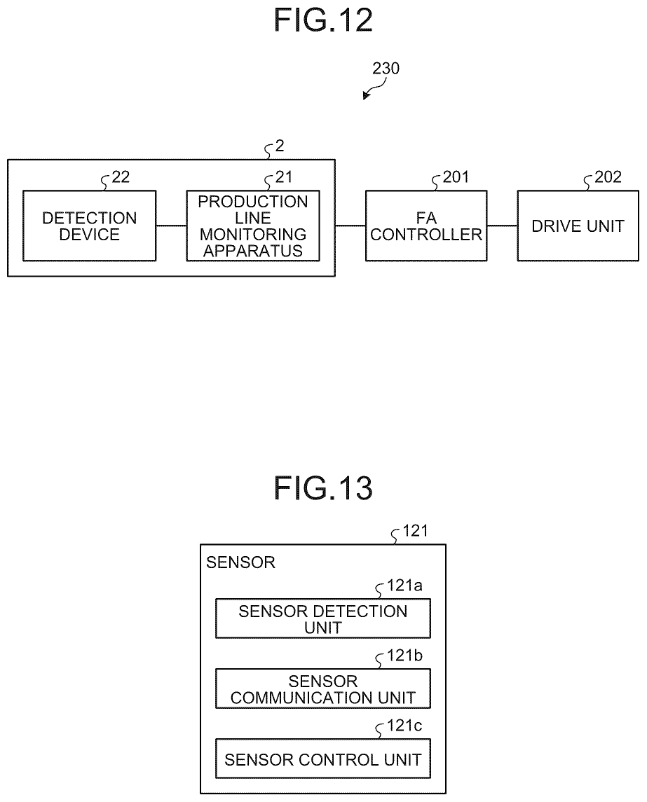

FIG. 12 is a diagram illustrating an FA system 230 using a production line monitoring system 2 according to a second embodiment. The FA system 230 according to the second embodiment is a control system including the production line monitoring system 2, the drive unit 202, and the FA controller 201. In the second embodiment, the same reference numerals are assigned to the same components as those of the first embodiment without detailed explanations.

Similarly to the production line monitoring system 1, the production line monitoring system 2 is a system that monitors a process in a factory production line, and includes a production line monitoring apparatus 21 and a plurality of detection devices 22. The production line monitoring system 2 captures images of the operating state of the production process using the detection devices 22, and detects an anomalous condition in the production process based on the captured operating state of the production process. Furthermore, the production line monitoring system 2 detects information on the state of the process in the production line that cannot be acquired from videos, using the detection devices 22, and detects an anomalous condition in the production process based on the detected information.

The detection device 22 is a state detection unit that detects the state of the process in the production line. The detection device 22 includes the plurality of cameras 111 and a plurality of sensors 121.

The sensors 121 are sensors that detect information on the state of the process in the production line that cannot be acquired from videos captured by the cameras 111. The state of the process in the production line that cannot be acquired from the videos is exemplified by the temperature of the product 207 or the production line. The plurality of sensors 121 are disposed around the belt conveyor 203 driven by the motor that is the drive unit 202 in the FA system 230. The plurality of sensors 121 are disposed in predetermined positions around the belt conveyor 203 different from each other where the product 207 or the state of the production line can be acquired. The number of the sensors 121 disposed should be sufficient to monitor any process to be monitored of a plurality of processes in the production line. If it is desired to monitor all the processes in the production line, the number of the sensors 121 disposed should be sufficient to monitor all the processes.

FIG. 13 is a block diagram illustrating a functional configuration of each sensor 121 of the production line monitoring system 2 according to the second embodiment.

Each sensor 121 includes a sensor detection unit 121a, a sensor communication unit 121b, and a sensor control unit 121c.

The sensor detection unit 121a is a state information acquisition unit that acquires information on the state of the process in the production line that cannot be acquired from videos captured by the cameras 111, under the control of the sensor control unit 121c.

The sensor communication unit 121b performs bidirectional wireless communication with the production line monitoring apparatus 21.

The sensor control unit 121c controls the entire sensor 121 including the sensor detection unit 121a and the sensor communication unit 121b. The sensor control unit 121c causes the sensor detection unit 121a to acquire the state of the process in the production line in a cycle which is stored in advance.

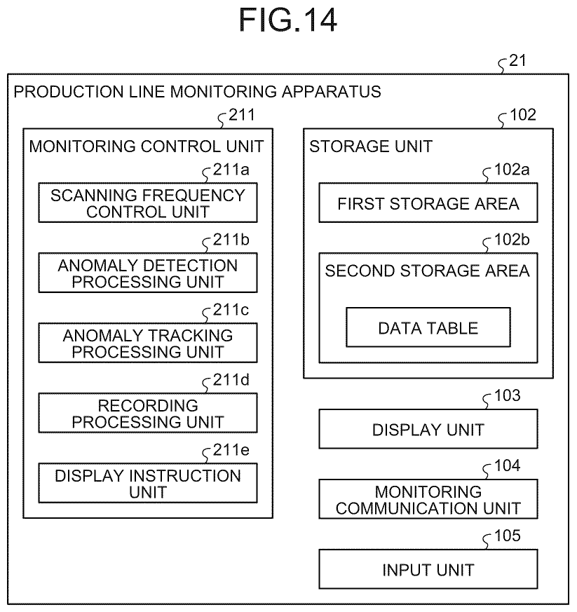

FIG. 14 is a block diagram illustrating a functional configuration of the production line monitoring apparatus 21 according to the second embodiment. Similarly to the production line monitoring apparatus 10 described above, the production line monitoring apparatus 21 is a monitoring apparatus for monitoring a process in a factory production line. The production line monitoring apparatus 21 detects an anomalous condition in the production process, based on the operating state of the production process captured using the cameras 111. Further, the production line monitoring apparatus 21 detects an anomalous condition in the production process based on information on the state of the process in the production line detected by the sensors 121. The production line monitoring apparatus 21 includes a monitoring control unit 211, the storage unit 102, the display unit 103, the monitoring communication unit 104, and the input unit 105. The components of the production line monitoring apparatus 21 can give and receive video data and information to and from each other.

The monitoring control unit 211 controls the entire production line monitoring apparatus 21. The monitoring control unit 211 includes a scanning frequency control unit 211a, an anomaly detection processing unit 211b, an anomaly tracking processing unit 211c, a recording processing unit 211d, and a display instruction unit 211e. The components of the monitoring control unit 211 can give and receive video data and information to and from each other.

When information on the known travel speed of the production line is input, the scanning frequency control unit 211a calculates an appropriate scanning frequency for collectively controlling the shutter speeds of the plurality of cameras 111 and collectively controls the shooting timings of the plurality of cameras 111.

The scanning frequency control unit 211a transmits, together with the scanning frequency, information on a time just coming to all the cameras 111 as information specifying the time to change the shutter speeds of the cameras 111 and start delivery of videos from the cameras 111. Thus, the scanning frequency control unit 211a performs processing to synchronize the shooting timings of the cameras 111, that is, the shutter timings of the cameras 111.

According to the information on the just-coming time received from the scanning frequency control unit 211a, each camera 111 changes the shutter speed based on the received scanning frequency and starts to deliver a video. By all the cameras 111 performing the above processing for synchronization, errors in time information on frames of videos captured by the cameras 111 can be minimized. Between the cameras 111, by minimizing errors in frame time information between frames in videos captured by the cameras 111, temporally cross-references become possible between video frames captured by different cameras 111.

The anomaly detection processing unit 211b compares video data transmitted from the plurality of cameras 111 and sensor detection information transmitted from the plurality of sensors 121 with information indicating a normal condition stored in advance, to detect an anomalous condition occurring in the production line. As a result of the comparison, when the product 207 or a condition in the production line found to have a difference equal to or larger than a predetermined threshold is shown in the videos acquired from the cameras 111, the anomaly detection processing unit 211b determines that an anomalous condition occurring in the production line has been detected and outputs an alarm.

Further, as a result of the comparison, when there is sensor detection information on the product 207 or a condition in the production line found to have a difference equal to or larger than a predetermined threshold, the anomaly detection processing unit 211b determines that an anomalous condition occurring in the production line has been detected and outputs an alarm. The anomaly detection processing unit 211b transmits alarm information to the FA controller 201 via the monitoring communication unit 104. In addition, the anomaly detection processing unit 211b performs the same processing as the anomaly detection processing unit 101b in the first embodiment.

The anomaly tracking processing unit 211c performs the same processing as the anomaly tracking processing unit 101c in the first embodiment.

The recording processing unit 211d performs the same processing as the recording processing unit 101d in the first embodiment.

The display instruction unit 211e performs the same processing as the display instruction unit 101e in the first embodiment.

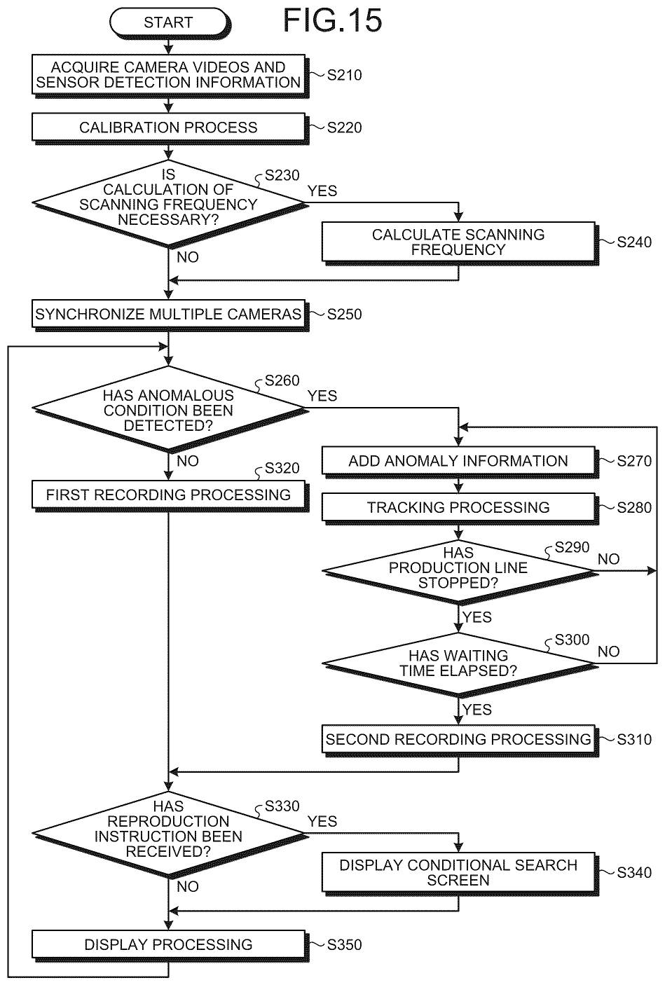

FIG. 15 is a flowchart illustrating an example of a processing procedure when the production line monitoring system 2 according to the second embodiment monitors the production line.

When the production line monitoring system 2 starts to monitor the production line, in step S210, a camera video acquisition step is performed to acquire camera videos of the production line captured by the cameras 111, which are monitoring videos of the production line to be monitored in the production line monitoring system 2. In the camera video acquisition step, the plurality of cameras 111 disposed around the production line to be monitored in the production line monitoring system 1 capture images of the production line to acquire video data on the production line. Here, the video data is overwritable video data.

In addition, a sensor detection step is performed in which the plurality of sensors 121 detect information on the state of the process in the production line to be monitored in the production line monitoring system 2. In the sensor detection step, the plurality of sensors 121 disposed around the production line to be monitored in the production line monitoring system 2 detect information on the state of the process in the production line to acquire sensor detection information.

Next, similarly to that in step S20 described above, the calibration process is performed in step S220.

Next, in step S230, the scanning frequency control unit 211a receives the known travel speed of the production line as input and stores the received travel speed as a history. The scanning frequency control unit 211a performs processing to determine whether it is necessary to calculate the scanning frequency for controlling the shutter speeds of the cameras 111. When the input travel speed of the production line is a new input value, the scanning frequency control unit 211a determines that it is necessary to calculate the scanning frequency. When the input travel speed of the production line is a previously input value and when the input value is sufficiently low, the scanning frequency control unit 211a determines that it is not necessary to calculate the scanning frequency.

When it is determined that the scanning frequency needs to be calculated, Yes is selected in step S230, and the process proceeds to step S240. When it is determined that the scanning frequency does not need to be calculated, No is selected in step S230, and the process proceeds to step S250.

In step S240, the scanning frequency is calculated. Specifically, the scanning frequency control unit 211a performs processing to calculate the scanning frequency appropriate for all the cameras 111 similarly to the first embodiment, based on the input value of the travel speed of the production line. The calculated scanning frequency is stored and held in the scanning frequency control unit 211a.

Next, in step S250, synchronization processing of the plurality of cameras 111 is performed similarly to the first embodiment. In the synchronization processing of the plurality of cameras 111, specifically, the scanning frequency control unit 211a transmits and feeds back the calculated scanning frequency to all the cameras 111. All the cameras 111 receive the scanning frequency transmitted from the scanning frequency control unit 211a. The shutter speeds of the cameras 111 are determined based on the value of the scanning frequency transmitted from the scanning frequency control unit 211a and become the same value.

Next, in step S260, an anomaly detection step of detecting an anomalous condition is performed to determine whether or not an anomalous condition has been detected in the production line. Specifically, the anomaly detection processing unit 211b compares video data acquired from the plurality of cameras 111 with video data indicating the normal condition of the production line stored in advance, to detect an anomalous condition occurring in the production line. That is, the anomaly detection processing unit 211b compares current videos of the production line acquired from the plurality of cameras 111 with videos showing the production line in the normal condition stored in advance, to detect an anomalous condition occurring in the production line.

Further, the anomaly detection processing unit 211b compares sensor detection information acquired from the plurality of sensors 121 with information indicating the normal condition stored in advance, to detect an anomalous condition occurring in the production line.

When it is determined that an anomalous condition has been detected in the production line, Yes is selected in step S260, and the process proceeds to step S270. When it is determined that no anomalous condition is detected in the production line, No is selected in step S260, and the process proceeds to step S320.

In step S270, an anomaly information addition step of adding anomaly information that is information regarding the anomalous condition is performed. The information regarding the anomalous condition is accompanying information which accompanies the anomalous condition. Specifically, the anomaly detection processing unit 211b adds the box 131 enclosing an anomalous portion of the anomalous condition detected in the videos to frames of the videos. The anomaly detection processing unit 211b adds header information that is overwriting disabling information to prohibit overwriting on the videos to the video data delivered from the cameras 111. The anomaly detection processing unit 211b performs processing to add information such as labeling information, information on the position coordinates in the video frames of an object detected as the anomalous condition detected in the video frames, information on the position coordinates in the video frames of a portion different from the normal condition, and the sensor detection information received from the sensors 121 as information regarding the anomalous condition added to the video data of the cameras 111.

At this time, for example, different videos obtained by coloring the videos based on information such as the depth of a flaw or temperature obtained by the sensors 121 may be additionally prepared.

Subsequent processing from step S280 to step S350 is the same as the processing from step S80 to step S150 in FIG. 6, and thus will not be described.

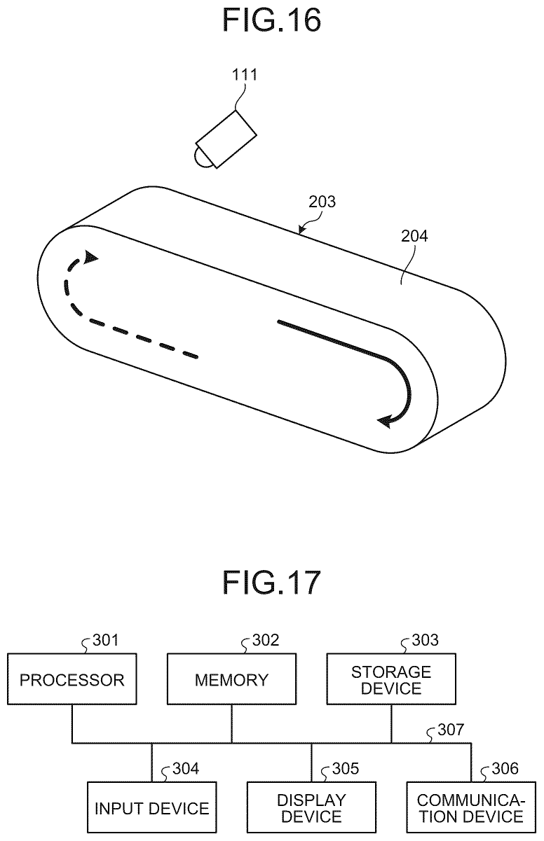

FIG. 16 is a diagram illustrating an example at the time of calculating the scanning frequency in the second embodiment. In the second embodiment, when the travel speed of the production line is known, after the ratio between the actual length unit and the pixel length unit is calculated by the calibration process, the user enters the travel speed of the production line into the production line monitoring apparatus 21, and the scanning frequency is calculated based on the numerical value of the entered travel speed of the production line. For example, the entry of the travel speed of the production line is Ms: rotational speed [rpm]. Then, the calculation result is 1/ω: scanning frequency [Hz].

When the travel speed of the production line is sufficiently low, and the time taken by an object on which anomalous condition determination is performed in videos to travel a unit distance is sufficiently greater than errors in time information between frames caused by differences in the shooting timings of the cameras 111 without sharing of the scanning frequency, the processing of detecting an anomalous condition may be started without calculating the scanning frequency. In this case, as illustrated in FIG. 16, the mark 130 attached to the production line in FIG. 7 is not attached to the production line.

The production line monitoring system 2 according to the second embodiment described above has the same effect as the production line monitoring system 1 according to the first embodiment.

Even when the rotational speed of the production line to be monitored by the production line monitoring apparatus 21 is known, a minimum shutter speed described in formula (1) in the first embodiment can be calculated, so that an appropriate scanning frequency can also be calculated. Therefore, the production line monitoring system 2 can introduce and control synchronization of the plurality of cameras 111 more easily than a monitoring system that introduces a plurality of single cameras, with respect to monitoring a process in a production line whose travel speed is known.

The production line monitoring system 2 may set an initial value of the shutter speeds of the cameras 111. If it is clear that the travel speed of the production line is sufficiently low, and the right side of formula (1) has a value sufficiently larger than the initial value of the shutter speed that is the left side, an appropriate scanning frequency is calculated as the reciprocal of the initial value of the shutter speed, and no other numerical values need to be entered. For this reason, the production line monitoring system 2 can be easily introduced to monitor a process in which the travel speed of the production line is sufficiently low.

The production line monitoring system 2 may be provided with a plurality of detection devices each including one camera 111, one sensor 121, and one anomaly detection processing unit 211b. In this case, the plurality of detection devices 22 are independent from each other. The camera 111 and the sensor 121 are individually connected to the anomaly detection processing unit 211b. In each detection device 22, the camera 111 delivers video data of an overwritable video to the anomaly detection processing unit 211b and the production line monitoring apparatus 21. The sensor 121 detects the product 207 flowing in the process of the production line or a condition in the production line, and transmits obtained sensor detection information to the anomaly detection processing unit 211b.

The anomaly detection processing unit 211b compares the video data transmitted from the camera 111 with video data showing the normal condition stored in advance. Further, the anomaly detection processing unit 211b compares the detection information acquired from the sensor 121 with information indicating the normal condition stored in advance as well. In addition, the anomaly detection processing unit 211b performs the same processing as the anomaly detection processing unit 211b described above and the anomaly detection processing unit 101b in the first embodiment.

The anomaly tracking processing unit 211c performs processing similarly to the first embodiment based on videos and information added to the videos output from each of the anomaly detection processing units 211b of the detection device 22. When it is determined that the identical anomalous condition is shown in the videos, the anomaly tracking processing unit 211c performs the tracking processing by tagging the videos as the identical anomalous condition.

By this configuration, the detection devices of the production line monitoring apparatus 21 include the plurality of cameras 111 and the plurality of anomaly detection processing units 211b, and each camera 111 may operate independently of the other cameras 111. Therefore, it becomes easier to handle the increase of the number of cameras 111 to the maximum number that is the processing limit of the production line monitoring system, or the reduction of the number of cameras 111 in accordance with a scale-down of the production line monitoring system. This facilitates maintenance of the production line monitoring system to flexibly respond to the user's desire, such as the increase of the number of cameras 111 to meet a request to add and incorporate a new production line into the same production line monitoring system, or the reduction of the number of cameras 111 to meet a request to reduce the production line monitoring apparatus at a portion that the user finds unnecessary after the introduction of the production line monitoring system.

Each of the production line monitoring apparatus 10 according to the first embodiment and the production line monitoring apparatus 21 according to the second embodiment described above is implemented by a computer system such as a personal computer or a general-purpose computer. FIG. 17 is a diagram illustrating a hardware configuration when the functions of each of the production line monitoring apparatus 10 according to the first embodiment and the production line monitoring apparatus 21 according to the second embodiment are implemented by the computer system. When the functions of each of the production line monitoring apparatus 10 and the production line monitoring apparatus 21 are implemented by the computer system, as illustrated in FIG. 17, the functions of each of the production line monitoring apparatus 10 and the production line monitoring apparatus 21 include a processor 301 that performs arithmetic processing, memory 302 used by the processor 301 as a work area, a storage device 303 that stores a program for operating as the devices of each of the production line monitoring apparatus 10 and the production line monitoring apparatus 21, an input device 304 that is an input interface with the user, a display device 305 that displays information to the user, and a communication device 306 having a function to communicate with other various devices. The processor 301, the memory 302, the storage device 303, the input device 304, the display device 305, and the communication device 306 are connected by a data bus 307. Here, the processor 301 may be a processing unit, an arithmetic device, a microprocessor, a microcomputer, a central processing unit (CPU), a digital signal processor (DSP), or the like. The memory 302 corresponds to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disk, a mini disk, a digital versatile disc (DVD), or the like.

Each of the monitoring control units 101 and 211 is implemented, for example, by the processor 301 executing a monitoring program stored in the memory 302 illustrated in FIG. 17. The monitoring program is a monitoring software program for performing the monitoring method described in the first and second embodiments on a computer. A plurality of processors and a plurality of memories may cooperate to implement the above functions. Some of the functions of the monitoring control unit 101 or 211 may be implemented as an electronic circuit, and the other functions may be implemented using the processor 301 and the memory 302.

The functions in the production line monitoring method performed by each of the production line monitoring apparatus 10 and the production line monitoring apparatus 21 are described as a monitoring program and stored in the storage device 303. The processor 301 reads the monitoring program stored in the storage device 303 into the memory 302 and executes the program, thereby implementing the functions of the production line monitoring apparatus 10 and the production line monitoring apparatus 21. That is, the computer system includes the storage device 303 for storing the monitoring program that results in execution of the steps to perform the production line monitoring method according to the first or second embodiment when the functions of each of the production line monitoring apparatus 10 and the production line monitoring apparatus 21 are performed by the processor 301.

This production line monitoring program can be said to cause a computer to perform processing implemented by the functions of each of the production line monitoring apparatus 10 and the production line monitoring apparatus 21. Specific examples of the display device 305 are a monitor and a display. Specific examples of the input device 304 are a keyboard, a mouse, and a touch panel.

The configurations described in the above embodiments illustrate an example and can be combined with another known art. The embodiments can be combined with each other. The configurations can be partly omitted or changed without departing from the gist.

### REFERENCE SIGNS LIST

1, 2 production line monitoring system; 10, 21 production line monitoring apparatus; 11 image-capturing device; 22 detection device; 101, 211 monitoring control unit; 101a, 211a scanning frequency control unit; 101b, 211b anomaly detection processing unit; 101c, 211c anomaly tracking processing unit; 101d, 211d recording processing unit; 101e, 211e display instruction unit; 102 storage unit; 102a first storage area; 102b second storage area; 103 display unit; 104 monitoring communication unit; 105 input unit; 111, 111-1, 111-2, 111-3, 111-4, 111-5 camera; 111a camera image-capturing unit; 111b camera communication unit; 111c camera control unit; 121 sensor; 121a sensor detection unit; 121b sensor communication unit; 121c sensor control unit; 130, 130L, 130R mark; 131 box; 132 thumbnail image; 200, 230 factory automation system; 201 FA controller; 202 drive unit; 203 belt conveyor; 204 conveyor belt; 205 roller shaft; 206 roller; 207 product; 301 processor; 302 memory; 303 storage device; 304 input device; 305 display device; 306 communication device; 307 data bus; 1031 video display area; 1031a slide bar; 1032 thumbnail display area; 1033 accompanying information display area; 1034 date and time information display area.

1. A production line monitoring apparatus to monitor a process in a factory production line, the apparatus comprising:
anomaly detection processing circuitry to detect an anomalous condition in the production line, based on videos acquired by a plurality of image-capturing circuitry disposed in different positions outside the production line monitoring apparatus to capture images of a state of the production line;
anomaly tracking processing circuitry to, when an anomalous condition has been detected by the anomaly detection processing circuitry, create a recorded video in which, of the videos captured by the plurality of image-capturing circuitry, videos in which an anomalous condition determined to be identical to the detected anomalous condition is captured are connected in a time series manner; and
recording processing circuitry to cause a storage circuitry to store the recorded video and accompanying information which accompanies the detected anomalous condition in association with each other.

2. The production line monitoring apparatus according to claim 1, comprising
scanning frequency control circuitry to calculate a scanning frequency for synchronizing shooting timings of the plurality of image-capturing circuitry, the scanning frequency being used by the plurality of image-capturing circuitry to determine the shooting timings.

3. The production line monitoring apparatus according to claim 1, wherein
the anomaly detection processing circuitry detects an anomalous condition in the production line, based on information on the state of the production line that is acquired by a plurality of sensors disposed in different positions outside the production line monitoring apparatus and is not possible to be acquired from the videos acquired by the image-capturing circuitry, or the videos acquired by the plurality of image-capturing circuitry.

4. The production line monitoring apparatus according to claim 1, wherein
the recording processing circuitry adds overwriting disabling information to prohibit overwriting to the videos in which the anomalous condition has been detected.

5. The production line monitoring apparatus according to claim 1, wherein
the recording processing circuitry causes the storage circuitry to store position information of the plurality of image-capturing circuitry, and
when an anomalous condition has been detected by the anomaly detection processing circuitry, the recording processing circuitry causes the storage circuitry to store information on the image-capturing circuitry that have captured videos in which the anomalous condition has been detected, the position information of the image-capturing circuitry that have captured the videos in which the anomalous condition has been detected, and a captured image of the detected anomalous condition in association with the captured videos.

6. The production line monitoring apparatus according to claim 1, wherein
the recording processing circuitry to cause the storage circuitry to store further at least one of information on a number of detections of the anomalous condition of the videos captured by the plurality of image-capturing circuitry or information on equipment disposed near one of the image-capturing circuitry whose number of detections of the anomalous condition is large in association with the captured videos.

7. The production line monitoring apparatus according to claim 1, comprising
display circuitry to display information stored in the storage circuitry.

8. The production line monitoring apparatus according to claim 7, wherein
the display circuitry displays real-time videos captured by the image-capturing circuitry or displays the recorded video stored in the storage circuitry together with the accompanying information which accompanies the anomalous condition.

9. A production line monitoring system to monitor a process in a factory production line, the system comprising:
the production line monitoring apparatus according to claim 1; and
plurality of image-capturing circuitry disposed in different positions outside the production line monitoring apparatus to capture images of a state of the production line.

10. A production line monitoring method to monitor a process in a factory production line, the method comprising:
detecting an anomalous condition in the production line, based on videos acquired by a plurality of image-capturing circuitry disposed in different positions outside the production line monitoring apparatus to capture images of a state of the production line;
creating when an anomalous condition has been detected in detecting the anomalous condition, a recorded video in which, of the videos captured by the plurality of image-capturing circuitry, videos in which an anomalous condition determined to be identical to the detected anomalous condition is captured are connected in a time series manner; and
causing a storage circuitry to store the recorded video and accompanying information which accompanies the detected anomalous condition in association with each other.

11. The production line monitoring method according to claim 10, comprising
calculating, by the production line monitoring apparatus, a scanning frequency for synchronizing shooting timings of the plurality of image-capturing circuitry, based on a travel speed of the production line, the scanning frequency being used by the plurality of image-capturing circuitry to determine the shooting timings.

12. The production line monitoring method according to claim 11, comprising
synchronizing time information on frames of the videos captured by the plurality of image-capturing circuitry by transmitting the scanning frequency to the plurality of image-capturing circuitry whose shooting ranges do not overlap so as to synchronize the shooting timings of the plurality of image-capturing circuitry.

13. The production line monitoring method according to claim 10, comprising
displaying real-time videos captured by the image-capturing circuitry on a display circuitry, or displaying, by the production line monitoring apparatus, the recorded video stored in the storage circuitry together with the accompanying information which accompanies the anomalous condition on the display circuitry.

14. A production line monitoring apparatus to monitor a process in a factory production line, the apparatus comprising:
anomaly detection processing circuitry to detect an anomalous condition in the production line, based on videos acquired by a plurality of image-capturing circuitry disposed in different positions outside the production line monitoring apparatus to capture images of a state of the production line;
anomaly tracking processing circuitry to, when an anomalous condition has been detected by the anomaly detection processing circuitry, create a recorded video in which, of the videos captured by the plurality of image-capturing circuitry, videos in which an anomalous condition identical to the detected anomalous condition is captured are connected in a time series manner; and
storage circuitry to store the recorded video and accompanying information which accompanies the detected anomalous condition in association with each other.
